(19) United States
(12) Patent Application Publication
(10) Pub. No.: US 2008/0183701 A1
(43) Pub. Date: Jul. 31, 2008

(54) SYSTEM AND METHOD FOR OBTAINING AND UPDATING AVAILABILITY OF CARE FACILITY BEDS AND RELATED FACILITY INFORMATION

(76) Inventors: STUART FURMAN, Valley Center, CA (US); LAURA FERRALL, Valley Center, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 12/022,836

(22) Filed: Jan. 30, 2008

Related U.S. Application Data
(60) Provisional application No. 60/887,279, filed on Jan. 30, 2007.

(51) Int. Cl. G06F 17/30; G06Q 10/00; G06F 7/10; G06Q 30/00

(52) U.S. Cl. 707/5; 707/10; 705/14; 705/7; 707/E17.017

(57) ABSTRACT

A system which can be used by the public through a website over a network to obtain information on the availability of beds and other information relating to care facilities for the elderly. This system can be accessed by the public and facilities so that the information stored in the system's database can be updated and amended. This system allows both the public and facilities to create profiles so that these profiles can be matched and a proper facility fit can be located.

### CROSS-REFERENCE TO RELATED APPLICATION

This application claims the benefit of priority pursuant to 35 U.S.C. §119 of co-pending U.S. Provisional Patent Application No. 60/887,279, filed Jan. 30, 2007, entitled “System and Method for Obtaining and Updating Availability of Care Facility Beds and Related Facility Information,” the disclosure of which is hereby incorporated by reference.

### FIELD OF THE INVENTION

The present invention generally relates to the field of obtaining updating and storing information on the availability of care facility beds and other information relating to the care facilities. More particularly this invention relates to the capabilities to do these searches and updates over and through the website.

### BACKGROUND OF INVENTION

The traditional and previous way for searching for a bed in an elder care facility through telephone book and senior directory (with merely alphabetical listings), and manual calling or physical visits to multiple facilities. The disclosed invention simplifies the process and makes it more expeditious and comprehensive.

### SUMMARY OF THE INVENTION

Systems and methods for obtaining, storing and updating availability of care facility beds and information related to care facilities will be described herein. These systems and methods function over a network and can be accessed by the public, care providers, and subscribing facilities over the internet or other communication network. This system centralizes the search for available skilled nursing facilities (SNF), board and care (RCFE), residential care (Assisted Living and Independent Living), and Alzheimer's facilities (“Facility”) beds and it contains other information relevant to these facilities which can be updated at any time. It is a network based real-time system, accessible from any network enabled computer, which can search for available care beds in selected search regions to assist in the discharge and subsequent admission of a patient/resident.

The network can be a personal area network (“PAN”), local area network (“LAN”), wide area network (“WAN”), or a distributed combination of networks collectively comprising a global communications network such as the Internet. The network can be fixed in location, mobile, or may comprise a combination of fixed and mobile components. Additionally, the network may carry communications corresponding to a single network protocol or to multiple network protocols. For example, the network may be a UWB network for carrying high bandwidth wireless traffic.

Both the public, care professionals (case managers, discharge planners, social workers, resident and review departments) and other care facilities will save significant amounts of time needlessly searching for a bed in an appropriate facility over the traditional manual search. This system has modules which make the public, and other users, aware of the existence of subscribing facilities with available and appropriate beds, when they need them. The facility is thus matched with a very targeted reader. This unique interactive system may provide real-time facility information including availability of beds, pricing, amenities, services, and other related information. The modules of the system allow searches for beds or other information to be targeted in the particular search regions as narrow as a zip code or broadened into an entire state if necessary. A facility uses this system to advertise or otherwise promote their facility and services as well as notify their consumers that they have availability.

This system includes but is not limited to features such as name, location including city, county, state and zip code, facility contact information, detailed profile of its availability, pricing, facility amenities, facility services and allows the facility to draft unique comments about their facility. The system also provides email and telephone support to facilities, a map and directions link through Yahoo Maps, Google Maps or other related service, email contact link to facilities, email request for brochure, facility logo (uploaded by the facility owner), web statistics to track new hits, web sitemap to personal or alternate web page, photographs of the facilities, promotions and specials on profile and/or other search results grid, priority search results placement and priority search results grid and a virtual tour capability on the profile.

In one embodiment this system further includes: 1) an interactive website whereby facilities maintain their availability and other related information, 2) a inquiry board to allow postings by care professionals and/or the public which than can be searched by the facility owners and messages can be sent by the facility owner to the poster, 3) a benefits package giving subscribers services at a discount or at no cost (for example, continuing education classes, background checks, first aid training, in house screening, and access to professional services such as accounting, real estate sales and loan financing, at rates negotiated by the principals of BedAvailability.com); 4) access to group type discounts for workers such as workers compensation, general liability, and other types of insurances; 5) monthly newsletters with relevant information; and 6) alliances with other complimentary businesses and professionals.

The users of the system include but are not limited to case management departments, skilled nursing facility administrators, RCFE (Residential Care Facility for the Elderly, as defined in California) administrators; assisted living administrators, special care facility administrators, independent care facility administrators, care professionals, independent case management companies, home care companies, seniors and families of frail seniors, senior referral agencies, geriatric physicians offices, and anyone in the general public searching for available care beds in the skilled nursing facilities, board and care facilities, assisted living facilities or the like. The system allows the subscribing facilities to be exposed to referral sources or families in a manner that cannot effectively or affordably be done on an individual basis by using the combined power of each individual subscribing facility to get the attention of referral sources and families. The system speeds up the discharge and subsequent admission, saving substantial amounts of time and money.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a high level network diagram illustrating an example system for executing updates and searches for care facility beds and related information according to an embodiment of the present invention;

FIG. 2 is an example database diagram or schema illustrating example of physical attributes for various types of facilities;

FIG. 3 is a an example database diagram or schema illustrating example data which may be included in the system;

FIG. 4 is a flow diagram illustrating an example of the types of users and their capabilities within the system;

FIG. 5 is a flow diagram illustrating an example process for the options a facility has when they enter the system;

FIG. 5A is a flow diagram illustrating an example process for how a facility logs-on and uses the system according to an embodiment of the present invention;

FIG. 6 is a flow diagram illustrating an example process for how to search for facilities according to an embodiment of the present invention;

FIG. 7 is a flow diagram illustrating an example process for logging onto the system;

FIG. 8 is a flow diagram illustrating an example process for how a care professional or public user can use the system via public use or log-on features;

FIG. 9 is a flow diagram illustrating an example process for how a to log-on and use the system; and

FIG. 10 is a block diagram illustrating an example computer system that may be used in connection with various embodiments described herein.

### DETAILED DESCRIPTION OF EMBODIMENT OF INVENTION

After reading this description it will become apparent to one skilled in the art how to implement the invention in various alternative embodiments and alternative applications. However, with all the various embodiments of the present invention will be described herein, it is understood that these embodiments are presented by way of an example only, and not limitation. As such, this detailed description of various alternative embodiments should not be construed to limit the scope or breadth of the present invention as set forth below.

Figure (“FIG.”) 1 is a high-level diagram of an example network 130 including this system 100. The network 130 can be a personal area network (“PAN”), local area network (“LAN”), wide area network (“WAN”), or a distributed combination of networks collectively comprising a global communications network such as the Internet. Network can be fixed in location, mobile, or may comprise a combination of fixed and mobile components. In one embodiment the network 130 can be the Internet. The system 100 communicates with users 150 and 152, and customers 140 and 142 via a network 130 such as the Internet. As an example, the users 150 and 152, and customer 140 and 142 are shown, however, it should be known that there can be an inordinate number of facilities, users and customers on the system. Users can view and update the system 100. The system has direct access with its application server 125. The application server 125, which in one embodiment can be on Internet Information Server (IIS), communicates directly with the database 115 which is a dynamic pool of information which is continually updated and added to by both the customers and the system administrator. In a preferred embodiment the web server is an Apache Server running on a Linux operating system. In another embodiment, the web application server 125 includes a primary application server and a back-up secondary server.

The web application server 125 generates a website which can be viewed by the users 152 and 150 and customers 142 and 140 over the network 130. In one embodiment the customer and user interface is through the Internet on a dynamic website which displays their search parameters and allows them to obtain and provide information to the system. The application server 125 includes various modules which each have their own functionality to enable the system to provide a method for obtaining and updating the availability of care facility beds and related facility information. The users 152 and 150 and the customers 142 and 140 interact with these modules to use the system 100.

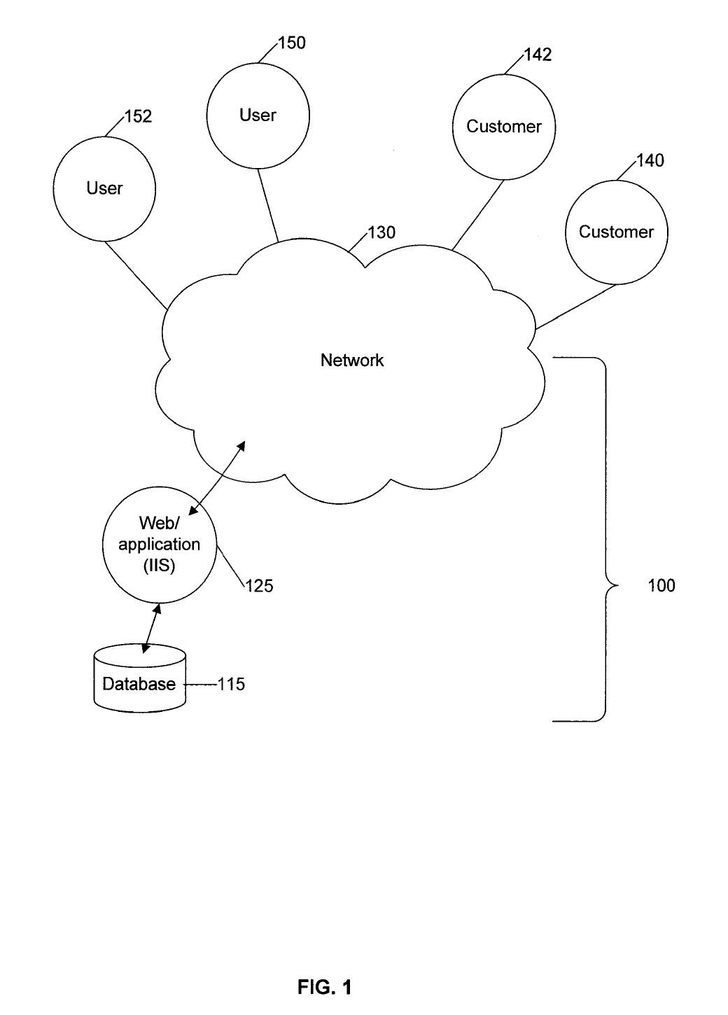

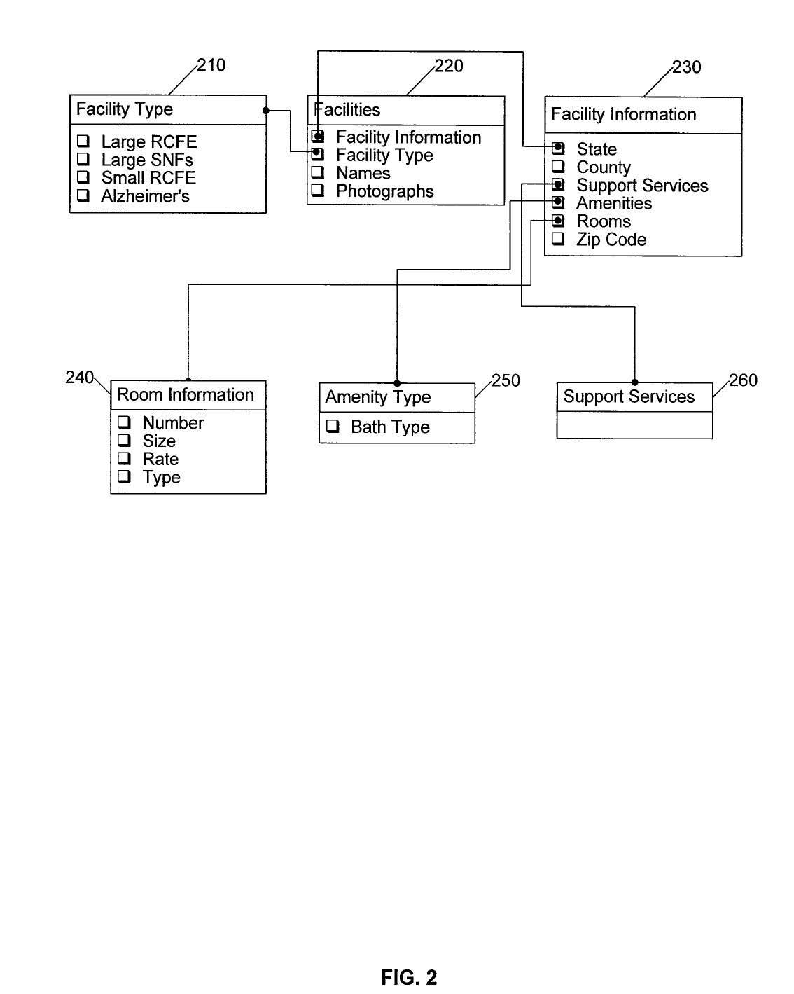

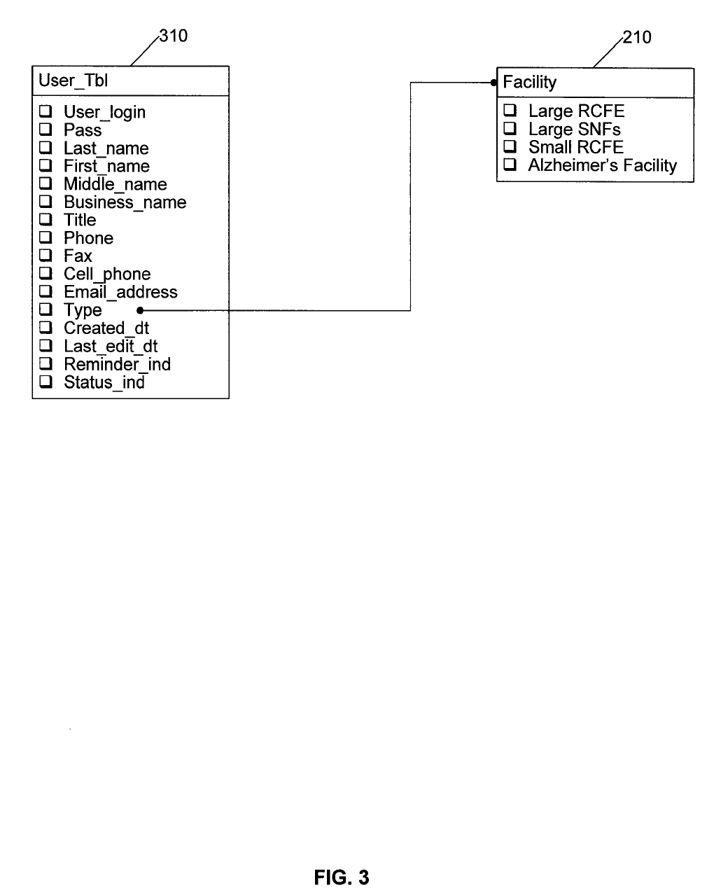

FIGS. 2 and 3 are database diagram or schema illustrating examples of a single site's physical attributes. This representation has been divided into two figures for convenience. The database can be implemented on the database server 115 of FIG. 1, which in on embodiment can be a MySql server. The database calls are made through embedded PHP scripts. This database includes multiple tables which have resident information. In the embodiment depicted, a very complete set of information for a site is maintained. Obviously, less complete data sets can also be used.

FIG. 2 displays multiple site tables 210, 220, 230, 240, 250, and 260. In one embodiment, a facility-type table 210 could include large RCFE's, large SNF's, small RCFE's and Alzheimers Facilities. The facility-type table 210 is connected to the facility table 220. The facilities table includes information such as facility information, facility type, names, and photographs. The facilities table has associated with it the facility information table 230. The facility information table 230 includes information such as state, county, support services, amenities, room and zip code. The facility's information table 230 has associated with it the room information table 240, the amenities type table 250 and support services table 260. The room information table may include information such as number of rooms, size of rooms, rate for rooms and type of rooms.

FIG. 3 is a database diagram or schema illustrating example data which may be included in the system which can be implemented on the database server 115 of FIG. 1. The schema includes a user table 310, a type table 320, and a facility-type table 210 and a professional table 340. The user table 310 includes a user log-in, a password, a last name, a first name, a middle name, a business name, a title, a phone number, a fax number, a cell phone, an email address, a type ID, a created date, a last edit date, a reminder index, and status index. The reminder index and status index will be explained in more detail below. The user table 310 is associated with the facility table 210. The facility table 320 includes a type of facility such as a large RCFE, large SNFS, small RCFE and Alzheimer's Facility.

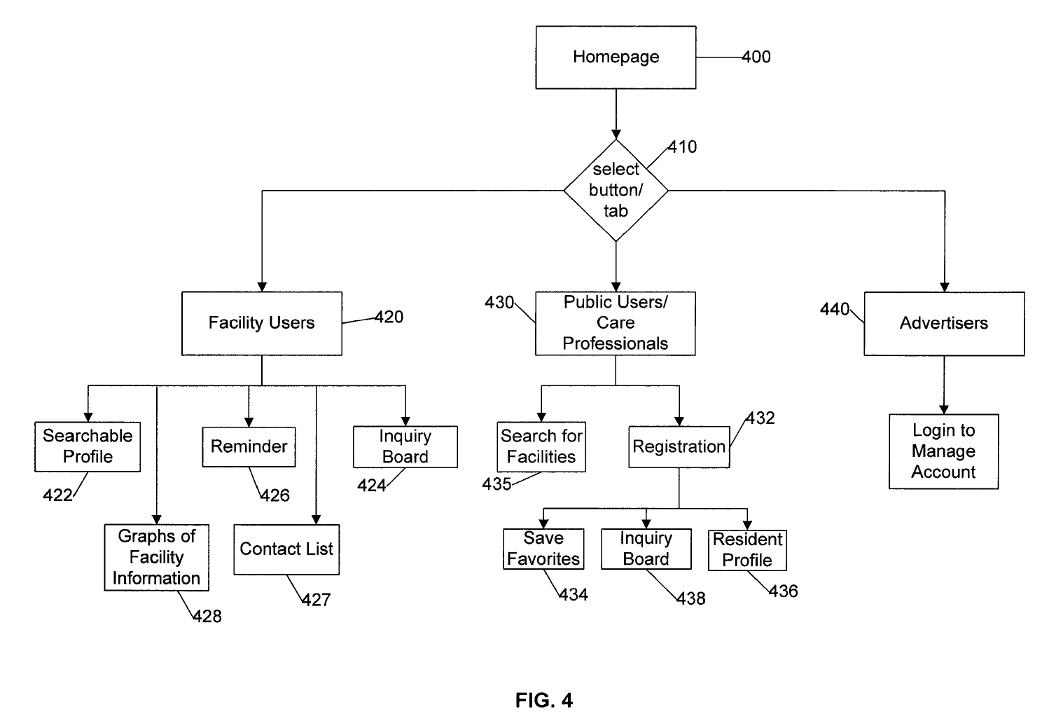

FIG. 4 is a flow diagram illustrating an example of types of users and their capabilities within the system. In one embodiment the user and/or customer accesses the system via a website 125 FIG. 1 over the Internet 130 FIG. 1. When a user/customer enters the system, they enter through the home page 400. The home page contains numerous buttons and tabs for various capabilities within the system 410. In one embodiment, these buttons or tabs could include Member Login, selection of State for search, Facility Owner, Public, Care Professional and Advertiser buttons to read additional information, about us, links to other websites, press feedback and contact information buttons.

At 410, the user/customer can select a button which would lead them to the facility user's module 420, the public user's module 430 or the advertisers user's module 440. From the facility user's module 420, the facility can go to searchable creation of a searchable profile module 422. In this module, the facility can create a searchable profile for their facility with detailed information about rates current availability of beds, amenities and services offered along with the ability to upload photos. From the facility user's module 420, the facility can also go the inquiry board module 424. From the inquiry board module 424, the facility can receive alerts and respond to them, it can search profiles of care professionals and the public and can initiate messages. From the facility user module 420, a user can also go to the reminder module 426. The reminder module 426 functions to notify the facility that it has not updated its information in a predetermined period of time. The reminders module 426 enables facilities to maintain current availability information and other facility information. From the facility user's module 420, the facility can also go to the graphs of facility information module 428. Module 428 allows the user to select a geographic area and obtain graphs showing facility statistics for the State and County selected. From the facility users module 420, the facility can go to the contact list module 427. Module 427 allows the facility to store contacts and to send group emails to these contacts.

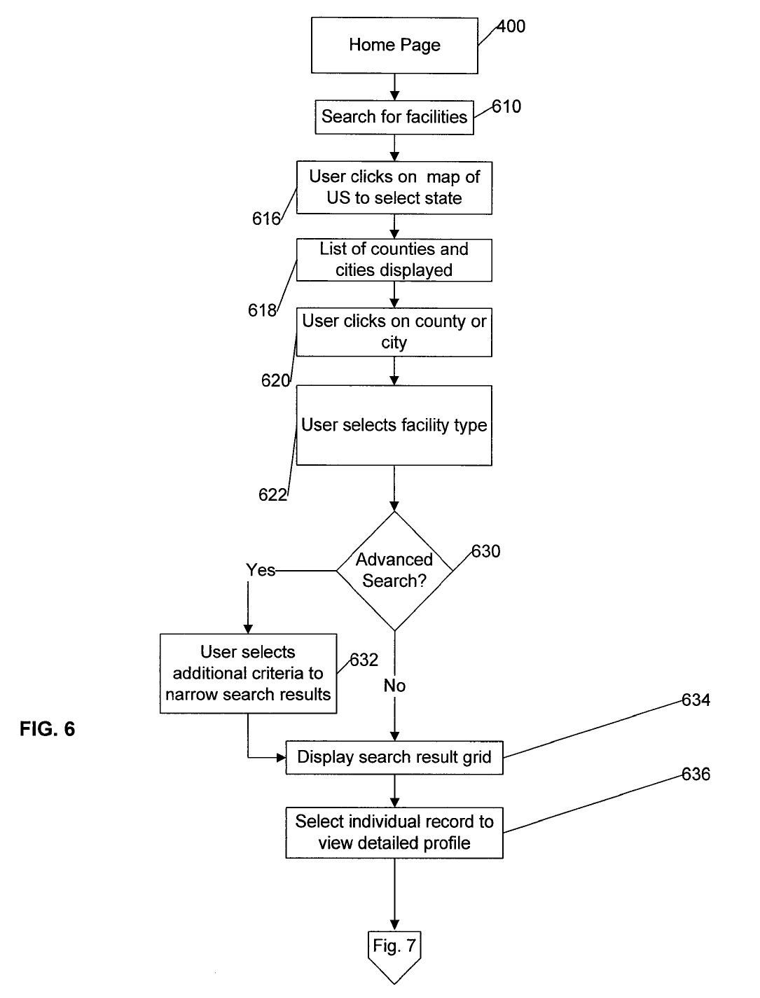

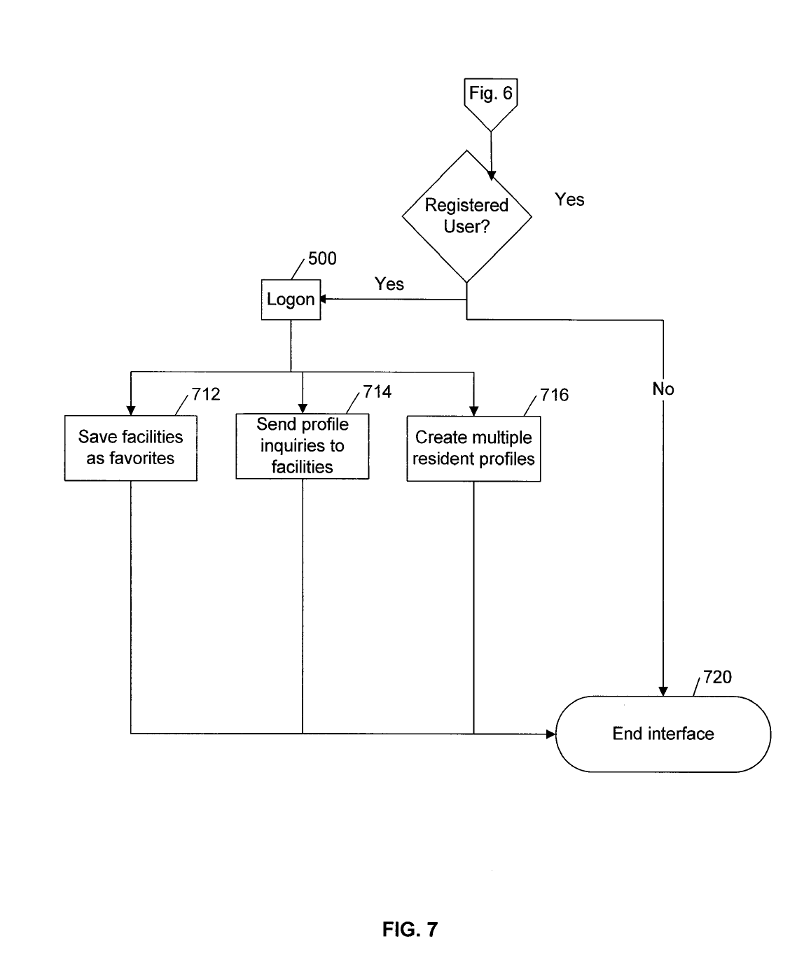

The public users/care professionals module 430 allows the users to either search for a facility at the facility module 435 or register on to the system through the registration module 432. At the public users/care professionals module 430 if the user chooses to search for facility at the search facility's module 435, they are prompted with a number of steps and requests. The process for searching facility is explained in more detail in FIG. 6 below. The public user can also log on to the system through the registration module 432. The registration process is explained in more details in FIG. 7. Once a user logs on to the system, they are able to use the functionalities in the save favorites module 434, the resident profile module 436 and the inquiry board module 438.

If the user chooses to use the save favorites module 434, this module allows registered users to save their searches as favorites so that they can later go back and retrieve the searches. If the user opts to use the resident profile module 436, this module enables them to post and create a profile which will be made public. User profiles include detailed information about elderly person, i.e. age, sex, physical condition, contact information for inquiring party and other notes and comments about needs and requirements. A Facility profile may include one or more of the following facility mapping location amenities pricing, room size, number of rooms, staffing and amenities. These profiles are used to send inquiries to facilities when searching for a facility. If the user chooses the inquiry board module 448, they will be capable of sending inquiries to a facility.

At the advertisers module 440, advertiser can view the types of advertising available or go to the log on module 442. If the advertiser logs on at the log on module 442 they can manage their advertisements. Advertisers will set up a profile of their company and pay to have their company listed in a searchable directory that is incorporated within the BedAvailability.com site. Premium service subscription will allow higher visibility and ranking of search results. Advertisements of various sizes, types, and for facility listings in different geographic areas can be purchased. A few types of advertising include one or two liners sponsored links, stationary banners or scrolling banners. In one embodiment advertising is paid for through Paypal®. Advertising subscriptions services will link to Paypal® checkout. If user has a Paypal® account, they enter their Paypal® email address and password to authorize the payment. If user does not have a Paypal® account, Paypal® will prompt user to create an account before payment can be authorized. In another embodiment advertising can be paid for by check.

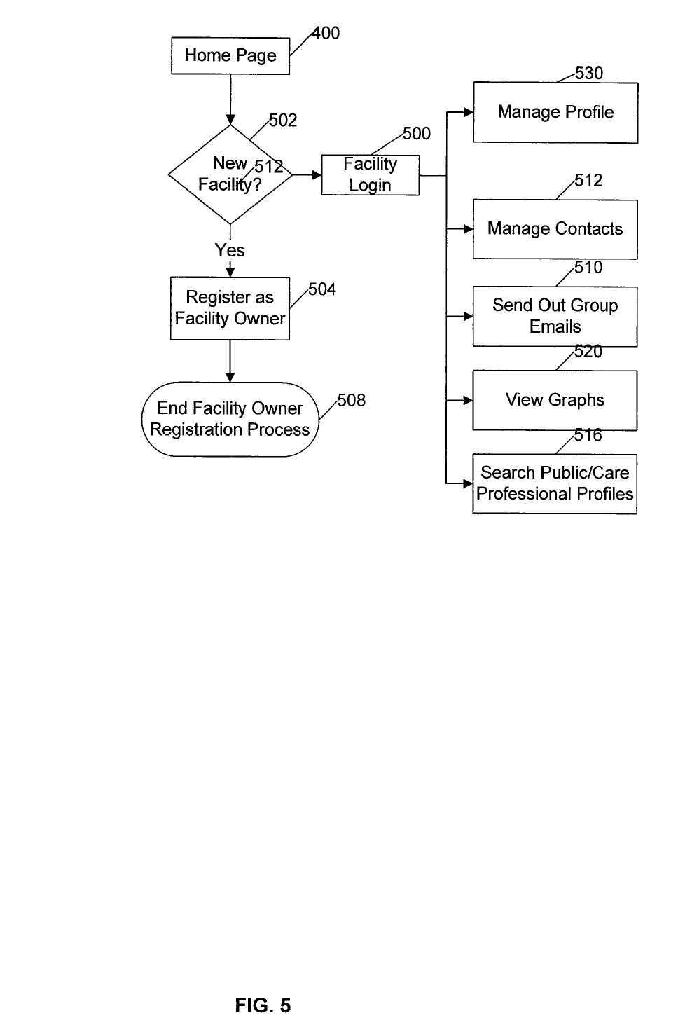

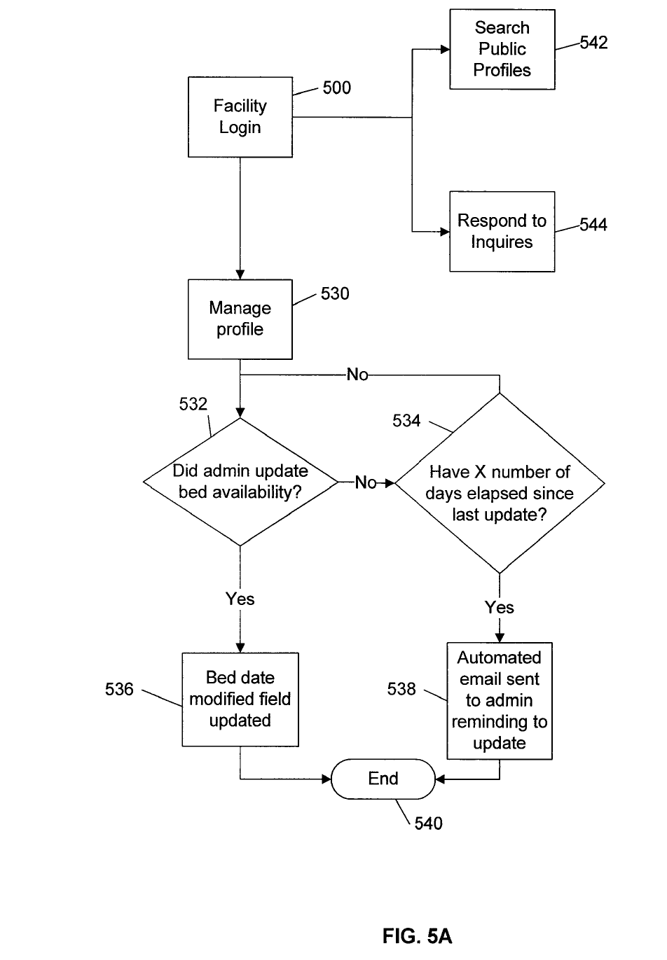

FIG. 5 is a flow diagram illustrating an example process for the options a facility has when they enter the system 100. The facility accesses the system 100 via a website 125 FIG. 1 over the Internet 130 FIG. 1. When a facility enters the system 100, they enter through the home page 400. At the home page, there is a button or tab which asks whether the facility is a new or existing user 502. The facility can choose to log on as an existing user or enter the registration process. If the facility chooses to log on 500, they enter their log on information and are entered into the system. Once the facility is entered into the system, they can manage their profile at the manage profile module 530 enter the message contacts module at 512, view graphs at module 520, send out group emails at module 510, or search public/care professional profiles at module 516.

If the facility enters “yes” to the new user interface request 502, then the facility is prompted to go through the registration for a facility owner at 504. Once the appropriate information has been entered and accepted and a password and user name have been approved the system 100 proceeds to its end at step 524.

FIG. 5A displays the capabilities of the search public profiles module 540, respond to inquiries module 442 and the manage profile module 530. At the search public profiles module 542, the facility can look for profiles which have been posted by the public or a care professional. At the respond to inquiries module 544 the facility can send emails responding to inquiries placed by the public and care professionals.

From the facility login module 500 the facility can also go to the manage profile module 530. From the manage profile module 530, a response feedback loop is initiated at step 532. If the facility has not updated its bed availability, the system checks to see the number of days that have elapsed since this update at step 534. If over a pre-determined number of days have elapsed since the last update, the system proceeds to step 538 at which point an automated email is sent to the administrator reminding them to update their bed availability. Once this email is sent, the process loop ends at 540. From the manage profile module 530 if the facility administrator chooses to update the number of available beds or other facility information, they proceed to step 536. At step 536, the facility can update its bed availability and other information relating to the facility.

FIG. 6 is a flow diagram illustrating an example process of how a care professional or a public user searches for facilities according to an embodiment of the present invention. The care professional or public user enters the home page 400 via the website 125 FIG. 1 over the Internet 130 FIG. 1. At the home page 400, there is a button or tab to search for facilities at step 610. At step 616, the user is presented with a graphical map of the United States with its states defined as clickable entries at step 616. At step 616, the user chooses clicks on the state in which they are looking for a facility. Once the state is selected, the system proceeds to step 618. At step 618 a list of counties and cities is displayed. The user then proceeds to step 620 where they can click on a particular county or city within the state. Once a particular county or city is selected at 620, a user is presented with a page showing icons representing the cluster of facilities. At step 622 the user can choose the type of facilities they are looking for and a list is displayed. A user can then select the facility which they are interested in at step 622. From here a user may refine their search further by choosing an advanced search art 630.

Once the user selects their search criteria, the system proceed to step 630 where the user is prompted to choose whether or not they want to enter into an advanced search. If the user selects an advanced search at step 630 they proceed to step 632 where they may select additional criteria to narrow their search results. Once the user has narrowed the search results, the display search result grid is presented to them at step 634. If the user chooses not to proceed with an advanced search at step 630, then the display search result grid from the previous basic search is displayed at step 634. From step 634, a user may select an individual record to view detail profile at step 636. Once the user has viewed the detailed profile they may choose to register in the system or end their interface with the system. If the user chooses to register in the system, they proceed onto registration which is set forth in more detail at FIG. 7.

FIG. 7 is a flow diagram illustrating an example process of logging onto the system. If a public user or professional care provider chooses to log onto the system once they have conducted a search, they may do so by selecting the log-on tab at step 500. Once logged on the user can search criteria in favorites at step 712, send profile inquiries to facilities at step 714, and create multiple resident profiles at step 716. From here, the user can perform additional searches or can end their search at step 720.

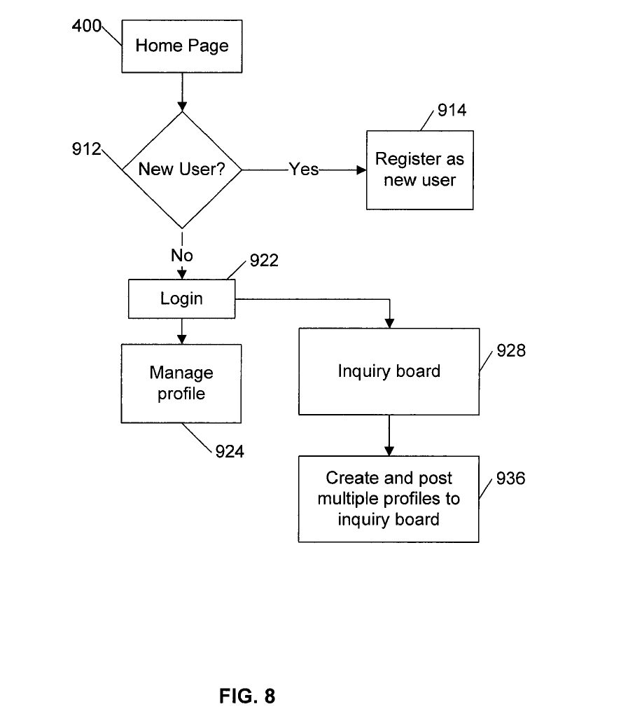

FIG. 8 is a flow diagram illustrating an example process of how a public user/care professional can use the system via public use or log on features. FIG. 8 displays the modules which can be used by the public user/care professional once they enter into the system. From the home page 400, the public user/care professional can either proceed to step 912 where they can log on to the system as a new user or register with their existing register information. If the user is not a new user, they proceed to the login step at 922. At the login step, the user enters all of its access codes and other related information at which point it is logged onto the system and can choose to enter many different modules.

The care professional/public user may enter the manage profile module 924. At this module, user can update their user profile. The public user/care professional may enter the inquiry board module 928. At this module they can create and post multiple profiles to the inquiry board at step 936 or receive emails from facilities responding to inquiry board postings at 938.

If the public user/care professional is a new user, it can register onto the system at step 914. Once the profile information is entered, the system proceeds to step 920 where the registration process is ended and the care professional is provided with their registration information and confirmation.

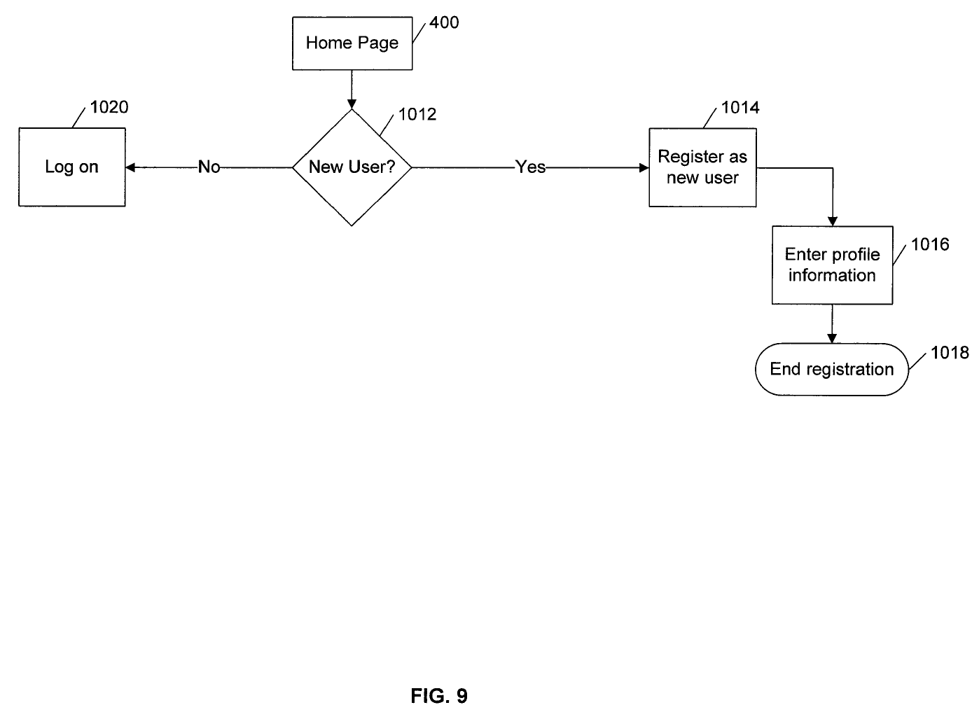

FIG. 9 is a flow diagram illustrating an example process of how public customer can log on and use the system. The public enters the system through the home page 400 which is accessed via a website 125 FIG. 1 over the Internet 130 FIG. 1. From the homepage the user can go to a log-in page which prompts the user to select whether or not they are a new user at step 1012. If the user is a new user, they proceed to step 1014 where they register as a new user. The system prompts the user to enter profile information at step 1016. Once the profile information is entered, the user receives confirmation of their registration and registration information, the registration process ends at step 1018. If the user is not a new user, they select the no button. The system then proceeds to the log on module 1020. The user enters their log on information at the log on module 1020 the user is allowed into the system once this information is entered correctly and accurately.

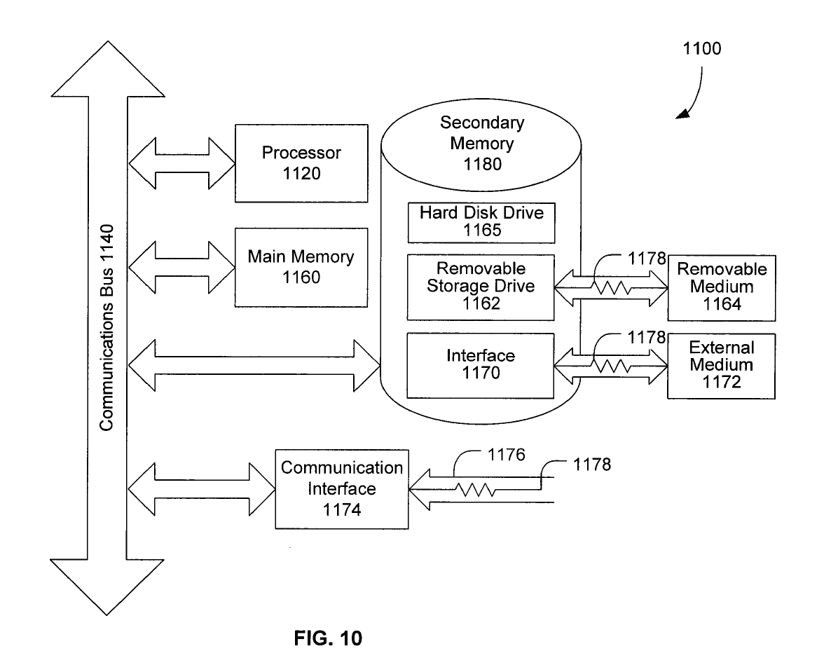

FIG. 10 is a block diagram illustrating an example computer system 1100 that may be used in connection with various embodiments described herein. For example, the computer system 1100 may be used in conjunction with obtaining and updating availability of care facility beds and related facility information. However, other computer systems and/or architectures may be used, as will be clear to those skilled in the art.

The computer system 1100 preferably includes one or more processors, such as processor 1120. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 1120.

The processor 1120 is preferably connected to a communication bus 1140. The communication bus 1140 may include a data channel for facilitating information transfer between storage and other peripheral components of the computer system 1100. The communication bus 1140 further may provide a set of signals used for communication with the processor 1120, including a data bus, address bus, and control bus (not shown). The communication bus 1140 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 1100 preferably includes a main memory 1160 and may also include a secondary memory 1180. The main memory 1160 provides storage of instructions and data for programs executing on the processor 1120. The main memory 1160 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 1180 may optionally include a hard disk drive 1165 and/or a removable storage drive 1162, for example a floppy disk drive, a magnetic tape drive, a compact disc (“CD”) drive, a digital versatile disc (“DVD”) drive, etc. The removable storage drive 1162 reads from and/or writes to a removable storage medium 1164 in a well-known manner. Removable storage medium 1164 may be, for example, a floppy disk, magnetic tape, CD, DVD, etc.

The removable storage medium 1164 is preferably a computer readable medium having stored thereon computer executable code (i.e., software) and/or data. The computer software or data stored on the removable storage medium 1164 is read into the computer system 1100 as electrical communication signals 1178.

In alternative embodiments, secondary memory 1180 may include other similar means for allowing computer programs or other data or instructions to be loaded into the computer system 1100. Such means may include, for example, an external storage medium 1172 and an interface 1170. Examples of external storage medium 1172 may include an external hard disk drive or an external optical drive, or and external magneto-optical drive.

Other examples of secondary memory 1180 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 1172 and interfaces 1170, which allow software and data to be transferred from the removable storage unit 1172 to the computer system 1100.

Computer system 1100 may also include a communication interface 1174. The communication interface 1174 allows software and data to be transferred between computer system 1100 and external devices (e.g. printers), networks, or information sources. For example, computer software or executable code may be transferred to computer system 1100 from a network server via communication interface 1174. Examples of communication interface 574 include a modem, a network interface card (“NIC”), a communications port, a PCMCIA slot and card, an infrared interface, and an IEEE 1394 fire-wire, just to name a few.

Communication interface 1174 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 1174 are generally in the form of electrical communication signals 1178. These signals 1178 are preferably provided to communication interface 1174 via a communication channel 1176. Communication channel 1176 carries signals 1178 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 1160 and/or the secondary memory 1180. Computer programs can also be received via communication interface 1174 and stored in the main memory 1160 and/or the secondary memory 1180. Such computer programs, when executed, enable the computer system 1100 to perform the various functions of the present invention as previously described.

In this description, the term “computer readable medium” is used to refer to any media used to provide computer executable code (e.g., software and computer programs) to the computer system 1100. Examples of these media include main memory 556, secondary memory 1160 (including hard disk drive 1165, removable storage medium 1164, and external storage medium 1172), and any peripheral device communicatively coupled with communication interface 1174 (including a network information server or other network device). These computer readable mediums are means for providing executable code, programming instructions, and software to the computer system 1100.

In an embodiment that is implemented using software, the software may be stored on a computer readable medium and loaded into computer system 1100 by way of removable storage drive 1162, interface 1170, or communication interface 1174. In such an embodiment, the software is loaded into the computer system 550 in the form of electrical communication signals 1178. The software, when executed by the processor 1120, preferably causes the processor 1120 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A system for obtaining and updating availability of care facility beds and related facility information, comprising:
a network in communication with the system and users and customers which include facilities;
a database configured to store and allow changes to information relating to care facilities;
a application server, which includes a number of modules which provide functionality, in contact with the database and the customers and users through the network; and
a website generated by the application server configured to allow customers to use the modules to access and update the information in the database.

2. The system of claim 1, wherein the database includes multiple tables with resident information about the care facilities.

3. The system of claim 2, wherein the tables include information relating to one or more of the following categories facility type, room information, amenity information, location, size, and support services.

4. The system of claim 1, wherein the application server includes a module which allows a customer to search for a facility by one or more of the parameters which include location, type, bed availability, size and support services.

5. The system of claim 1, which includes a advertising module configure to allow a customer to pay for and place advertising on the system.

6. The system of claim 1, which includes a searchable profile module configured to allow the user or facility to create a profile relating to their specific needs or facility attributes.

7. The system of claim 1, which includes an inquiry module configured to allow a facility to receive alerts and respond to them.

8. The system of claim 1, which includes a reminder module configured to notify a care facility that it has not updated its information and allows the facility to enter information updates to the system.

9. The system of claim 1, which includes a graphs module configured to allow the user to select a geographic area and obtain graphs showing facility statistics for the geographic area selected.

10. The system of claim 1, which includes a profile module and an inquiry module, the profile module configured to post and create a profile which will be made public on the website, and the inquiry module configured to send the profile to a customer who matches the parameters in the profile.

11. A computer implemented method for obtaining and updating the availability of care facility beds and other information, the method comprising:
receiving from a user a request for a particular type and location of care facility bed or information about a facility matching these parameters via a communications network;
checking a database containing dynamic information relating to care facilities and bed availability resident on a server;
identifying one or more available care facility beds which match the request;
sending the information identified to the user via a communications network; and
displaying this information to the user on a website page.

12. The method of claim 11, further comprising displaying advertisements to a user on the website.

13. The method of claim 11, further comprising displaying a geographic map of available care facility beds to the user on a webpage.

14. The method of claim 11, further comprising reminding a user that it has not updated its information and allowing the user to enter informational updates to the system.

15. The method of claim 11, further comprising logging onto the system to allow the user to access an inquiry board and create and update profiles.

16. A computer implemented method for obtaining and updating the availability of care facility beds and other information, the method comprising:
receiving information from a facility regarding the facility information and bed availability;
updating a database resident on a server with this information;
identifying one or more customer profiles which match this information;
sending the information to the customer with the matching profile; and
displaying this information to the customer on a website page.
